(19) United States
(12) Patent Application Publication
(10) Pub. No.: US 2023/0339369 A1
(43) Pub. Date: Oct. 26, 2023

(54) VEHICLE SEAT AUTO-ADJUST BASED ON REAR SEAT OCCUPANCY

(71) Applicant: Ford Global Technologies, LLC, Dearborn, MI (US)

(72) Inventors: Brendan Diamond, Grosse Pointe, MI (US); Keith Weston, Canton, MI (US); Jordan Barrett, Milford, MI (US); Andrew Denis Lewandowski, Sterling Heights, MI (US)

(73) Assignee: Ford Global Technologies, LLC, Dearborn, MI (US)

(21) Appl. No.: 17/660,577

(22) Filed: Apr. 25, 2022

(51) Int. Cl. B60N 2/02; B60N 2/00

(52) U.S. Cl. CPC B60N 2/0244; B60N 2/002; B60N 2002/0268

(57) ABSTRACT

The disclosure generally pertains to systems and methods for automatic adjustment of a seat in a vehicle. In an example method, a processor may evaluate a detector signal to determine an occupancy status of a second seat located behind a first seat in a vehicle. The processor may then execute a seat movement operation of the first seat based on the occupancy status of the second seat. The seat movement operation may involve either moving the first seat backwards over a first distance based on the second seat being unoccupied or moving the first seat backwards over a second distance that is smaller than the first distance based on the second seat being occupied. The first seat may be moved backwards at either a first speed of movement or a second speed of movement based on factors such as an available separation distance between the first seat and the second seat.

### BACKGROUND

Features may be added to vehicles in order to make the vehicles more attractive to buyers. One example of such a feature is an automatic door unlock system that automatically unlocks a door of a vehicle upon detecting a driver approaching the vehicle. The detection may be carried out by a vehicle computer that authenticates a handheld wireless device carried by the driver and unlocks the door based on communications between the vehicle computer and the handheld wireless device (a key fob or a smartphone, for example). Another feature is a vehicle trunk opening system that senses a trigger movement performed by a person and automatically opens the trunk without the person having to touch any buttons on the vehicle. The action performed by the person can be, for example, moving a foot under a sensor located adjacent to an edge of the trunk.

It is desirable to provide for more such features that offer convenience and comfort.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an example vehicle that includes a vehicle seat auto-adjust system in accordance with an embodiment of the disclosure.

FIG. 2 illustrates a first example scenario where the vehicle seat auto-adjust system operates in accordance with an embodiment of the disclosure.

FIG. 3 illustrates a second example scenario where the vehicle seat auto-adjust system operates in accordance with an embodiment of the disclosure.

FIG. 4 illustrates a third example scenario where the vehicle seat auto-adjust system operates in accordance with an embodiment of the disclosure.

FIG. 5 illustrates a fourth example scenario where the vehicle seat auto-adjust system operates in accordance with an embodiment of the disclosure.

FIG. 6 illustrates a first example flowchart of an operation executed by a vehicle seat auto-adjust system in accordance with a first embodiment of the disclosure.

FIG. 7 illustrates a second example flowchart of an operation executed by a vehicle seat auto-adjust system in accordance with a second embodiment of the disclosure.

FIG. 8 shows some example components that may be included in a vehicle in accordance with an embodiment of the disclosure.

### DETAILED DESCRIPTION

### Overview

In terms of a general overview, certain embodiments described in this disclosure are directed to systems and methods for automatic adjustment of a seat in a vehicle. In an example method, a processor may evaluate a detector signal to determine an occupancy status of a second seat that is located behind a first seat in a vehicle. The first seat can be a motorized driver seat and the second seat can be a rear passenger seat that is located behind the driver seat. The processor may then execute a seat movement operation of the first seat based on the occupancy status of the second seat. The seat movement operation may involve either moving the first seat backwards over a first distance based on the second seat being unoccupied or moving the first seat backwards over a second distance that is smaller than the first distance based on the second seat being occupied. The first seat may be moved backwards at either a first speed of movement or a second speed of movement based on various factors such as, for example, an available separation distance between the first seat and the second seat.

### Illustrative Embodiments

The disclosure will be described more fully hereinafter with reference to the accompanying drawings, in which example embodiments of the disclosure are shown. This disclosure may, however, be embodied in many different forms and should not be construed as limited to the example embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the described example embodiments but should be defined only in accordance with the claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure.

Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words and phrases are used herein solely for convenience and such words and terms should be interpreted as referring to various objects and actions that are generally understood in various forms and equivalencies by persons of ordinary skill in the art. More particularly, the word “adult” as used herein refers to any individual who does not require a child seat to be seated in a vehicle. An “adult” can, for example, range in age from a teenager to a senior citizen. It must be understood that words such as “implementation,” “scenario,” “case,” and “situation” as used herein are an abbreviated version of the phrase “In an example (“implementation,” “scenario,” “case,” “approach,” and “situation”) in accordance with the disclosure.” Furthermore, the word “example” as used herein is intended to be non-exclusionary and non-limiting in nature.

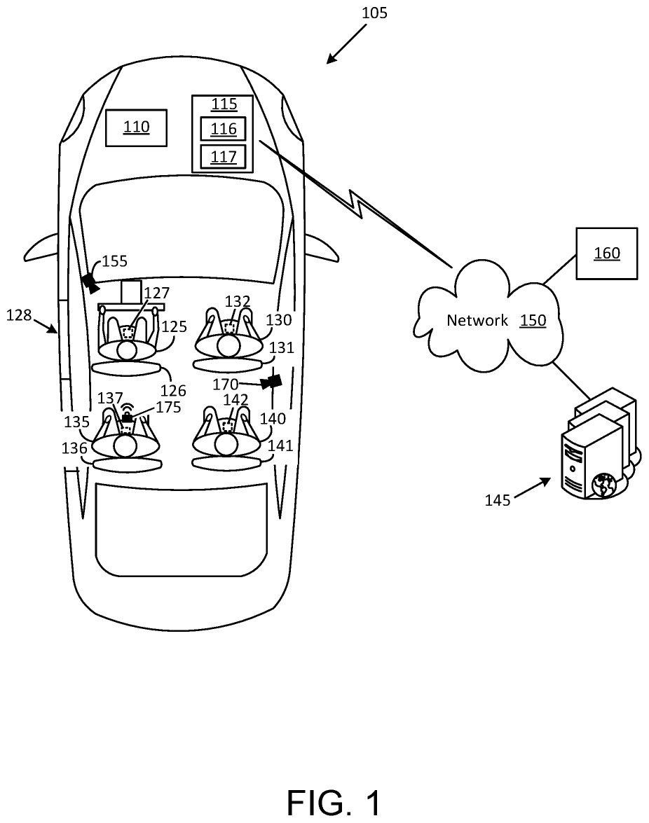

FIG. 1 illustrates an example vehicle 105 that includes a vehicle seat auto-adjust system 115 in accordance with an embodiment of the disclosure. The vehicle seat auto-adjust system 115 can include a processor 116 that is configured to execute computer-executable instructions stored in a memory 117 for performing various operations in accordance with the disclosure. The vehicle 105 may be any of various types of vehicles such as, for example, a gasoline powered vehicle, an electric vehicle, a hybrid electric vehicle, an autonomous vehicle, a sedan, a van, a minivan, a sports utility vehicle, a truck, a station wagon, or a bus. The illustrated example vehicle 105 contains four seats arranged in two rows. In other embodiments, the vehicle 105 can have more than four seats that are arranged in two or more rows.

The vehicle 105 can include various devices that may be communicatively coupled to the vehicle seat auto-adjust system 115 via wired (vehicle bus, coaxial jack, USB port, etc.) or wireless communication links (Bluetooth®, Ultra-Wideband (UWB), cellular, Wi-Fi, Zigbee®, near-field-communications (NFC), etc.). Additional devices such as, for example, a key fob, a handheld personal device (a smartphone, for example), and a wearable device (a smartwatch, for example) can be brought into the vehicle 105. These additional devices may also communicate with the vehicle seat auto-adjust system 115 via various types of wireless communication links.

The vehicle 105 may further include components such as, for example, a vehicle computer 110, one or more cameras, and one or more sensors. The cameras can be any of various types of cameras such as, for example, a digital camera that is configured to capture and convey still images to the vehicle seat auto-adjust system 115 or a video camera that is configured to capture and convey real-time video and/or video clips to the vehicle seat auto-adjust system 115. The cameras can be mounted upon any part of the vehicle 105 and oriented to have a field of view that encompasses one or more occupants of the vehicle 105 and at least a portion of a cabin area of the vehicle 105.

In the illustrated example, the vehicle includes a camera 155 that may be mounted upon a dashboard, a ceiling, or a front driver side pillar, and is oriented to capture images and/or video of one or more occupants of the vehicle 105. In the illustrated example, the camera 155 is oriented to capture images and/or video of the driver 125 who is seated in a driver seat 126 of the vehicle 105. The field of view may also extend to capture images and/or video of various parts of the vehicle 105 (such as, for example, a driver door 128) and other occupants of the vehicle 105 such as, for example, a passenger 135 who is seated in a rear passenger seat 136 located directly behind the driver seat 126. Another example camera 170 is mounted upon a side pillar of the vehicle 105 and oriented to capture images and/or video of various parts of the vehicle 105 and of occupants of the vehicle 105. In the illustrated example, the camera 170 is oriented to capture images and/or video of the passenger 135 who is seated behind the driver 125.

The sensors provided in the vehicle 105 can include any device that can detect a presence of a person in the vehicle 105. A few example devices can include a camera, a pressure sensor, a weight sensor, a proximity sensor, an infrared sensor, and an ultrasonic sensor. An example radar detector 175 is shown mounted upon the rear passenger seat 136 and configured for measuring an available separation distance between a front edge of the rear passenger seat 136 and a rear edge of the driver seat 126. The radar detector 175 may also be mounted at various other locations in the cabin of the vehicle 105, such as, for example, on a rear panel of the driver seat 126, a side pillar of the vehicle 105, or a ceiling of the cabin of the vehicle 105.

The vehicle seat auto-adjust system 115 is configured to detect the presence of one or more people in the vehicle 105 based, for example, on evaluating an image, a video clip, and/or a video stream provided by a camera. The vehicle seat auto-adjust system 115 may also be configured to detect the presence of a person occupying a seat, based on evaluating a sensor signal provided by a sensor. In the illustrated example, the vehicle 105 includes a sensor 127 provided in the driver seat 126, a sensor 132 provided in a front passenger seat 131 that is located adjacent to the driver seat 126, a sensor 137 provided in the rear passenger seat 136 located behind the driver seat 126, and a sensor 142 provided in a rear passenger seat 141 that is located adjacent to the rear passenger seat 136.

The vehicle seat auto-adjust system 115 may be configured to evaluate a sensor signal provided by the sensor 127 to detect the presence of the driver 125 occupying the driver seat 126. The vehicle seat auto-adjust system 115 may be further configured to evaluate a sensor signal provided by the sensor 132 to detect the presence of a passenger 130 occupying the front passenger seat 131, a sensor signal provided by the sensor 137 to detect the presence of the passenger 135 occupying the rear passenger seat 136, and a sensor signal provided by the sensor 142 to detect the presence of a passenger 140 occupying the rear passenger seat 141.

The vehicle computer 110 may perform various operations associated with the vehicle 105, such as controlling engine operations (fuel injection, speed control, emissions control, braking, etc.), managing climate controls (air conditioning, heating etc.), activating airbags, and issuing warnings (check engine light, bulb failure, low tire pressure, etc.).

In the illustrated example, the vehicle seat auto-adjust system 115 is configured to communicate and interact with the vehicle computer 110 for performing various operations in accordance with the disclosure. The vehicle seat auto-adjust system 115 is further configured to communicate via a network 150, with devices located outside the vehicle 105 such as, for example, a computer 145 (a server computer, a cloud computer, etc.) and a cloud storage device 160.

In an example scenario, the vehicle seat auto-adjust system 115 may wirelessly communicate with the computer 145 and/or the cloud storage device 160 for obtaining various types of information about the vehicle 105. A few examples of such types of information can include vehicle specifications. The vehicle specifications can include, for example, dimensional information, seat layout information, door information, and automation features information.

More particularly, the vehicle specifications can provide information such as, for example, a size of the vehicle 105 (sedan, truck, van, minibus, etc.), a size of a seating area in the vehicle 105, an available spacing between various seats in the vehicle 105, seat layout (2-row, 3-row, number of seats in each row, spacing between seats in a row, etc.), type of each seat (fixed, movable, motorized, non-motorized etc.), separation distance between edges of seats, number of doors (2-door, 4-door, etc.), type of doors (sliding, swing-open, gull-wing. etc.), type of door locks, type of door latches, door auto-lock features, door auto-open features, etc.

In another example scenario, the vehicle seat auto-adjust system 115 may gather certain types of information about the vehicle 105 and transmit the information to the cloud storage device 160 for storage. Some examples of the types of information gathered by the vehicle seat auto-adjust system 115 can include, for example, a time duration for the driver door 128 to open half-way, a time duration for the driver door 128 to open fully, and a speed of movement of the driver seat 126.

Such information may be derived on the basis of evaluating images obtained from one or more cameras in the vehicle 105 and or based on sensor signals obtained from various sensors provided in the vehicle 105 (such as, for example, a proximity sensor, an infrared sensor, or an ultrasonic sensor). The information stored in the cloud storage device 160 by the vehicle seat auto-adjust system 115 may be accessed later on by the vehicle seat auto-adjust system 115 on an as-needed basis, and in some cases, may be made available for use by a vehicle seat auto-adjust system provided in another vehicle.

The network 150 may include any one, or a combination of networks, such as, for example, a local area network (LAN), a wide area network (WAN), a telephone network, a cellular network, a cable network, a wireless network, and/or private/public networks such as the Internet. The network 150 may support any of various communication technologies such as, for example, Wi-Fi, Wi-Fi direct, Ultra-Wideband (UBW), cellular, machine-to-machine communication, and/or man-to-machine communication.

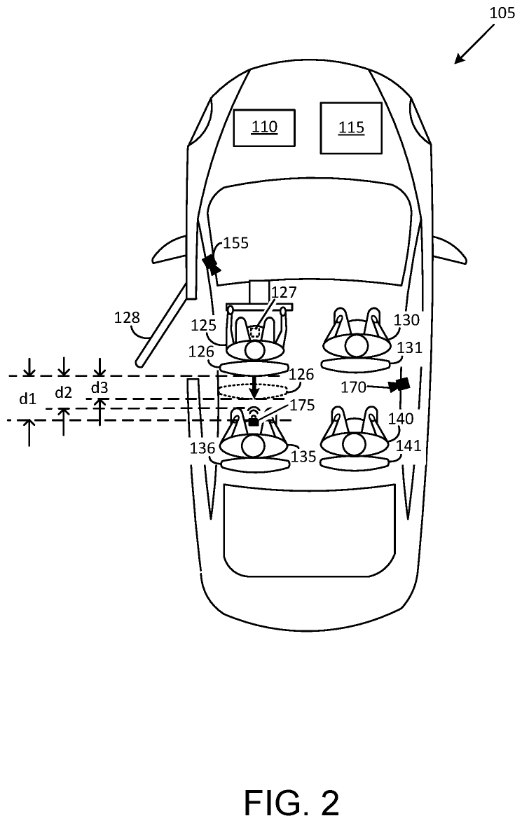

FIG. 2 illustrates a first example scenario where the vehicle seat auto-adjust system 115 operates in accordance with an embodiment of the disclosure. In this example scenario, the driver 125 has opened the driver door 128 and intends to exit the vehicle 105. The vehicle seat auto-adjust system 115 detects the opening of the driver door 128 in any of various ways, such as, for example, by receiving a signal from a sensor or a switch that detects an activation of a door unlock handle provided on the driver door 128, by receiving a signal from a sensor or a switch that detects an activation of a door unlatch handle provided on the driver door 128, and/or by evaluating an image received from the camera 155 and/or the camera 170.

In an example implementation, the vehicle seat auto-adjust system 115 detects the opening of the driver door 128 upon receiving a dome-light activation signal that automatically turns on a dome-light in the vehicle 105. The dome-light activation signal and associated operations are typically provided as standard equipment in most vehicles.

The vehicle seat auto-adjust system 115 determines an occupancy status of the rear passenger seat 136 that is located directly behind the driver seat 126. The occupancy status of the rear passenger seat 136 may be determined in various ways such as, for example, based on receiving a signal from the sensor 137 located in the rear passenger seat 136 (as shown in FIG. 1), by evaluating an image provided by the camera 155 and/or by evaluating an image provided by the camera 170.

In this example scenario, the passenger 135 is seated in the rear passenger seat 136. The vehicle seat auto-adjust system 115 may further determine that the passenger 135 is an adult. The determination may be made, for example, by evaluating the signal provided by the sensor 137 (a weight sensor or a pressure sensor, for example) and/or by evaluating one or more images provided by the camera 155 and/or the camera 170.

The vehicle seat auto-adjust system 115 can obtain certain types of information about the driver seat 126 from the cloud storage device 160, such as, for example, whether the driver seat 126 is a motorized seat that can be controlled by signals provided to the driver seat 126 by the vehicle computer 110 and/or by signals provided to the driver seat 126 by the vehicle seat auto-adjust system 115. In this example scenario, the driver seat 126 is a motorized seat that is configured to respond to control signals provided by the vehicle seat auto-adjust system 115 (either directly or via cooperation with the vehicle computer 110).

In an example operation in accordance with the disclosure, the vehicle seat auto-adjust system 115 automatically moves the driver seat 126 backwards over a distance “d3” based on detecting the opening of the driver door 128 and the occupancy of the rear passenger seat 136 by the passenger 135 (an adult, in this example). The distance “d3” may be determined by the vehicle seat auto-adjust system 115 based on various parameters such as, for example, based on a distance “d1” extending between a rear edge of the driver seat 126 and a front edge of the rear passenger seat 136 and a distance “d2” extending between a rear edge of the driver seat 126 and a body part of the passenger 135 (a knee, in the illustrated scenario).

The various distances, such as, for example, the distance “d1,” the distance “d2” and the distance “d3,” as well as other dimensional parameters (seat dimensions, cabin area dimensions, etc.) may be obtained and/or determined by the vehicle seat auto-adjust system 115 in various ways. In an example implementation, the various distances may be determined by evaluating one or more images provided to the vehicle seat auto-adjust system 115 by the camera 170 (for example) and/or by measured parameters provided to the vehicle seat auto-adjust system 115 by a measuring device provided in the vehicle 105 such as, for example, the radar detector 175. In at least some applications, image information can be combined with radar measurements for obtaining cumulative information such as, for example, an occupancy status of the rear passenger seat 136 and one or more of the various distances (d1, d2, d3, etc.). In another example implementation, at least some of the distance parameters may be obtained from the cloud storage device 160 and/or with assistance provided by the driver 125 based on instructions provided to the driver 125 by the vehicle seat auto-adjust system 115 (via an infotainment system or a handheld personal device, for example). The vehicle seat auto-adjust system 115 may also obtain additional information from the cloud storage device 160 such as, for example, a maximum movement distance that is available for moving the driver seat 126 backwards, and may ensure that the distance “d3” that is selected is less than the maximum movement distance. More particularly, in this example scenario, the distance “d3” is selected to avoid the rear edge of the driver seat 126 making contact with the knee of the passenger 135.

The speed of movement of the driver seat 126 may also be selected based on factors such as, for example, the distance “d3” and/or the status of the driver door 128 (closed, ajar, moving outwards, partially open, fully open, etc.). In one example scenario, the driver seat 126 may be moved backwards at a constant pre-set speed irrespective of the distance “d3” and/or the status of the driver door 128. In another example scenario, the driver seat 126 may be moved backwards at a first speed when for example, the driver door 128 is unlocked, and at a second speed when for example, the driver door 128 is fully open. In yet another example scenario, the driver seat 126 may be moved backwards at a variable speed that is determined on the basis of the position of the driver 125 (fully seated, partially out of the driver seat 126, fully out of the driver seat 126, etc.) and/or a body part contact of the driver 125 with the driver seat 126 (back of the driver 125 partially touching the driver seat 126, back of the driver 125 not touching the driver seat 126, hand of the driver 125 on the door handle, hand of the driver 125 released from door handle, etc.).

It must be understood that the description provided herein with respect to the driver seat 126 and the rear passenger seat 136 is equally applicable to any pair of seats in the vehicle 105 that have a similar configuration. Thus, for example, the vehicle seat auto-adjust system 115 can automatically move the front passenger seat 131 backwards over a distance “d3” based on detecting the opening of the front passenger door and based on the occupancy of the rear passenger seat 141 by the passenger 140 (an adult, in this example).

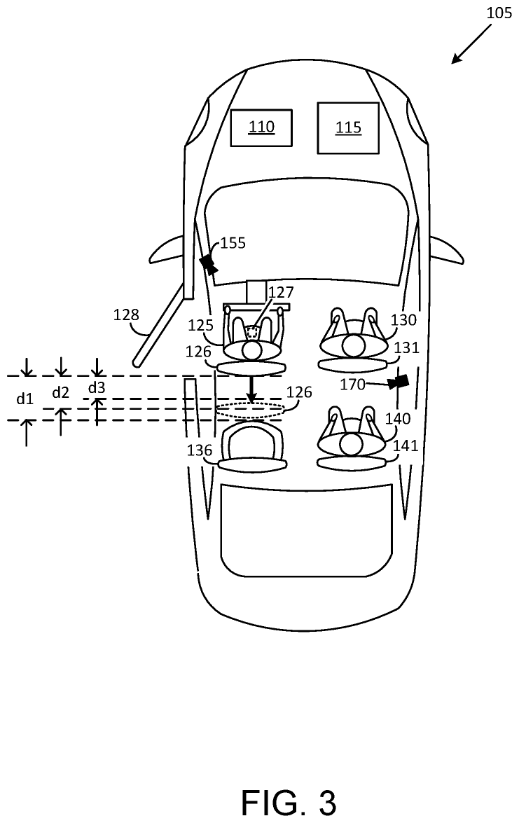

FIG. 3 illustrates a second example scenario where the vehicle seat auto-adjust system 115 operates in accordance with an embodiment of the disclosure. The second example scenario is substantially similar to the first example scenario except for the fact that the rear passenger seat 136 in this case is unoccupied.

In this case, the vehicle seat auto-adjust system 115 automatically moves the driver seat 126 backwards over the distance “d1” based on detecting the opening of the driver door 128 and/or the unoccupied status of the rear passenger seat 136. The distance “d1” is greater than the distance “d2” that was selected above. A speed of movement of the driver seat 126 may also be selected based on factors such as, for example, the distance “d1” and the status of the driver door 128 (closed, ajar, moving outwards, partially open, fully open, etc.).

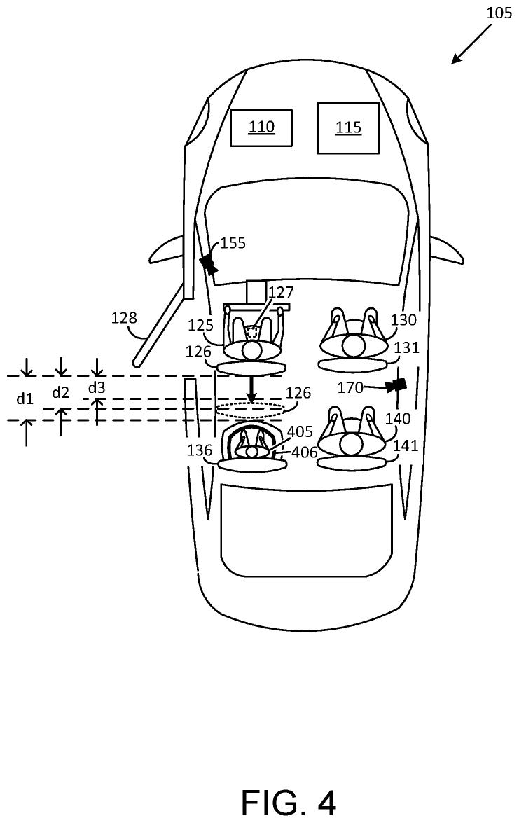

FIG. 4 illustrates a third example scenario where the vehicle seat auto-adjust system 115 operates in accordance with an embodiment of the disclosure. The third example scenario is substantially similar to the second example scenario described above except for the fact that a child seat 406 is mounted upon the rear passenger seat 136. The child seat 406 may or may not be occupied in this example scenario. When occupied, no body part (foot, hand, etc.) of a child 405 seated in the child seat 406 extends beyond the front edge of the rear passenger seat 136.

In this case, the vehicle seat auto-adjust system 115 automatically moves the driver seat 126 backwards over the distance “d1” based on detecting the opening of the driver door 128 and the presence of the child seat 406 mounted upon the rear passenger seat 136. A speed of movement of the driver seat 126 may be selected based on factors such as, for example, the distance “d1” and/or the status of the driver door 128 (closed, ajar, moving outwards, partially open, fully open, etc.).

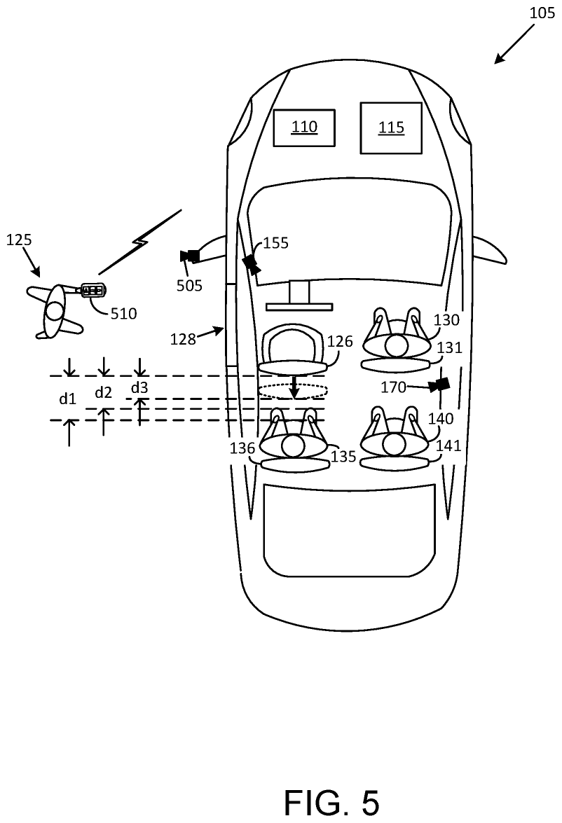

FIG. 5 illustrates a fourth example scenario where the vehicle seat auto-adjust system 115 operates in accordance with an embodiment of the disclosure. The second example scenario is substantially similar to the first example scenario except for the fact that the driver seat 126 in this case is unoccupied. The driver seat 126 may be unoccupied as a result of the driver 125 being outside the vehicle 105. In the illustrated scenario, the driver 125 is approaching the vehicle 105 and has a handheld device that can be used for opening the driver door 128. The handheld device in this example is a key fob 510 that includes an “unlock door” button, a “lock door” button, and a panic button. The driver 125 may activate the “unlock door” button when in the proximity of the vehicle 105. The key fob 510 transmits a wireless signal to the vehicle computer 110 and the vehicle computer 110 unlocks the driver door 128 upon receiving and authenticating the wireless signal received from the key fob 510.

In an example implementation in accordance with the disclosure, the vehicle computer 110 transmits a signal to the vehicle seat auto-adjust system 115 to inform the vehicle seat auto-adjust system 115 about the unlocking operation carried out in response to the activation of the “unlock door” button on the key fob 510. The vehicle seat auto-adjust system 115 may then execute a seat moving operation to move the driver seat 126 backwards when the driver 125 opens the driver door 128 so as to provide room for the driver 125 to comfortably enter the vehicle 105. In this case, the vehicle seat auto-adjust system 115 automatically moves the driver seat 126 backwards over a distance “d3” based on detecting the opening of the driver door 128 and the occupancy of the rear passenger seat 136 by the passenger 135 (an adult, in this example). In other cases, the vehicle seat auto-adjust system 115 automatically moves the driver seat 126 backwards over other distances based on the occupancy status of the rear passenger seat 136 as described above.

In another example implementation, the vehicle seat auto-adjust system 115 may directly receive the wireless signal transmitted by the key fob 510 and execute a seat moving operation to move the driver seat 126 backwards prior to the driver 125 reaching the driver door 128 and touching the door handle. In this case, the vehicle seat auto-adjust system 115 automatically moves the driver seat 126 backwards over a distance “d3” based on detecting the occupancy of the rear passenger seat 136 by the passenger 135 (an adult, in this example). In other cases, the vehicle seat auto-adjust system 115 automatically moves the driver seat 126 backwards over other distances based on the occupancy status of the rear passenger seat 136 as described above.

In another example implementation, the vehicle seat auto-adjust system 115 may directly receive the wireless signal transmitted by the key fob 510 and execute a seat moving operation to move the driver seat 126 backwards upon receiving a signal from a sensor or a switch that detects an activation of a door unlock handle provided on the driver door 128. The seat moving operation to move the driver seat 126 backwards may also be carried out upon receiving a signal from a sensor or a switch that detects an activation of a door unlock handle provided on the driver door 128 if the driver 125 decides to open the driver door 128 without use of the key fob 510. In either of these situations, the vehicle seat auto-adjust system 115 automatically moves the driver seat 126 backwards over a distance “d3” based on detecting the occupancy of the rear passenger seat 136 by the passenger 135 (an adult, in this example). In other cases, the vehicle seat auto-adjust system 115 automatically moves the driver seat 126 backwards over other distances based on the occupancy status of the rear passenger seat 136 as described above.

In another example implementation, the vehicle seat auto-adjust system 115 may evaluate one or more images received from a camera 505 that is oriented to have a field of view that allows image capture of the driver 125 approaching the vehicle 105 from any of various angles. The vehicle seat auto-adjust system 115 may execute a seat moving operation to move the driver seat 126 backwards upon detecting the driver 125 approaching the vehicle 105. In some cases, a threshold separation distance value between the driver 125 and the driver door 128 may be used to ensure that the driver 125 intends to enter the vehicle 105.

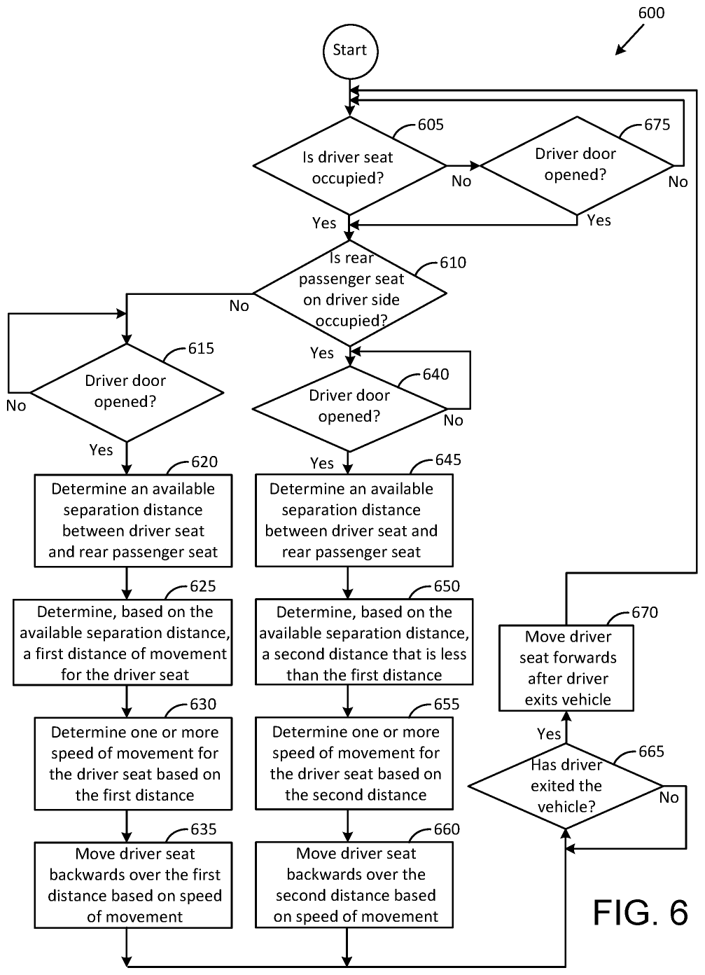

FIG. 6 shows a first example flowchart 600 of an operation executed by the vehicle seat auto-adjust system 115 in accordance with a first embodiment of the disclosure. The flowchart 600 illustrates a sequence of operations that can be implemented in hardware, software, or a combination thereof. In the context of software, the operations represent computer-executable instructions stored on one or more non-transitory computer-readable media such as the memory 117 that is a part of the vehicle seat auto-adjust system 115, that, when executed by one or more processors such as the processor 116 that is a part of the vehicle seat auto-adjust system 115, perform the recited operations. Generally, computer-executable instructions include routines, programs, objects, components, data structures, and the like that perform particular functions or implement particular abstract data types. The order in which the operations are described is not intended to be construed as a limitation, and any number of the described operations may be carried out in a different order, omitted, combined in any order, and/or carried out in parallel. The description below may refer to certain actions executed upon various components shown in FIG. 1 through FIG. 5, but it should be understood that the description is equally applicable to various other components and embodiments. Various actions and operations described below may be executed by the processor 116 of the vehicle seat auto-adjust system 115. Some of these actions may be carried out based on evaluating signals received from sensors or switches and/or based on evaluating images captured by one or more cameras provided in the vehicle 105. For example, the opening of a door may be detected by evaluating a signal received from a door latch sensor or switch and/or based on evaluating an image captured by a camera such as, for example, the camera 155 or the camera 170.

At block 605, the vehicle seat auto-adjust system 115 makes a determination whether the driver seat 126 of the vehicle 105 is occupied. In an example scenario, the driver 125 may be seated in the driver seat 126. In another example scenario, the driver 125 may not be present in the vehicle 105. If the driver seat 126 is unoccupied (as illustrated in FIG. 3 and described above), at block 675, a determination is made whether the driver door 128 has been opened (as illustrated in FIG. 5 and described above). If the driver door 128 has not been opened, the action indicated in block 605 is repeated in a recursive manner together with the action indicated in block 675.

If the driver door 128 is opened, such as, for example, by use of the key fob 510 (shown in FIG. 5) or by activation of the door handle in the driver door 128, at block 610, a determination is made whether the rear passenger seat 136 on the driver side is occupied. The action indicated at block 610 is also carried out if the driver seat 126 is occupied.

If the rear passenger seat 136 is not occupied, at block 615, a determination is made whether the driver door 128 has been opened for purposes of allowing the driver 125 to exit the vehicle 105. If the driver door 128 is not opened, the action indicated in block 615 is repeated in a recursive manner.

If the driver door 128 is opened, at block 620, an available separation distance between the driver seat 126 and the rear passenger seat 136 is determined. In this case, the rear passenger seat 136 is unoccupied. Consequently, the available separation distance corresponds to the separation distance “d1” that is illustrated in FIG. 3.

At block 625, a first distance of movement for the driver seat 126 is determined based on the available separation distance between the driver seat 126 and the rear passenger seat 136. In this case, the driver seat 126 can be moved back a distance “d1” that corresponds to the available separation distance “d1” determined in block 615.

At block 630, one or more speed of movement for the driver seat 126 can be determined. The speed of movement may be determined on the basis of various factors such as, for example, an occupancy status of the rear passenger seat 136 (in this case, unoccupied), and an available separation distance between the driver seat 126 and the rear passenger seat 136 (in this case, “d1”).

At block 635, the driver seat 126 is automatically moved backwards under control of the processor 116 in the vehicle seat auto-adjust system 115. In this case, the processor 116 moves the driver seat 126 backwards over a distance “d1” at the speed of movement determined in block 630.

At block 665, a determination is made whether the driver 125 has exited the vehicle 105. This operation may be carried out by evaluating a signal received from a switch or sensor in the driver door 128 and/or by evaluating an image captured by a camera (such as the camera 155, for example). If the driver 125 has not yet exited the vehicle 105, the action indicated in block 665 is repeated in a recursive manner until the driver 125 exits the vehicle 105.

If the driver 125 has exited the vehicle 105, at block 670, the driver seat 126 is moved forwards over a distance that corresponds to distance over which the driver seat 126 was moved backwards as described above with reference to block 635.

Referring back to block 610, if the rear passenger seat 136 is occupied, at block 640, a determination is made whether the driver door 128 has been opened. If the driver door 128 is not opened, the action indicated in block 640 is repeated in a recursive manner.

A passenger 135 is seated in the rear passenger seat 136 as determined in block 610. Consequently, at block 645, an available separation distance between the driver seat 126 and a body part of the passenger 135 (a knee, in the scenario illustrated in FIG. 2) is determined. In general, the available separation distance between the driver seat 126 and the body part of the passenger 135 can be dependent upon a position of the driver seat 126 at a time prior to the driver door 128 being opened. The position of the driver seat 126 at the time prior to the driver door 128 being opened may be a preferred seat position that may be set in accordance with a personal preference of the driver 125 (some drivers prefer to sit closer to the steering wheel than others). In some vehicles, one or more such preferred seat positions of the driver seat 126 may be stored in a memory of the vehicle computer 110. In such configurations, the driver seat 126 may automatically adjust to conform to a preferred seat position in response to the driver 125 touching a button on a side console of the driver seat 126.

Accordingly, the distances “d1,” “d2,” and “d3” may vary from one preferred position to another. If the maximum allowable separation distance “d1” between the driver seat 126 and the rear passenger seat 136 is deemed to correspond to 100%, in one example scenario, a preferred position of the driver 125 may provide a 75% separation distance “d2” and in another example scenario may provide a 25% separation distance “d2.” In the scenario that is illustrated in FIG. 2, the available separation distance corresponds to the separation distance “d2.”

At block 650, a second distance of movement for the driver seat 126 is determined based on the available separation distance between the driver seat 126 and the body part of the passenger 135. In this case, the driver seat 126 can be moved back a distance “d3” that is less than the available separation distance “d2” determined in block 645. The second distance of movement “d3” is less than the first distance of movement “d1” that is described above with reference to block 625, due to the presence of the passenger 135 seated in the rear passenger seat 136.

At block 655, one or more speed of movement for the driver seat 126 can be determined. The speed of movement may be determined based on various factors such as, for example, the distance of movement “d3” and a desire to neither alarm nor injure the passenger 135 seated in the rear passenger seat 136. The speed of movement in this case can be slower than the speed of movement in the case where the rear passenger seat 136 is unoccupied (as described above with reference to block 630).

At block 660, the driver seat 126 is moved backwards over the second distance “d3.” In an example implementation, the driver seat 126 can be moved backwards at a constant speed. In another example implementation, the driver seat 126 can be moved backwards at a non-linear speed (at a fast speed over a first distance and a slow speed over a remaining distance). In another example implementation, the driver seat 126 can be moved backwards at two or more speeds such as, for example, at a first speed over a first distance and a second speed over a second distance. In another example implementation, the driver seat 126 can be moved backwards at a predetermined speed over a third distance that is less than the second distance “d3.” The driver seat 126 may then be stopped in order to allow the passenger 135 to open the rear driver-side door and exit the vehicle 105. The third distance can be a predetermined distance that provides the passenger 135 adequate room to exit the vehicle 105. The driver 125 can remain seated in the driver seat 126 and wait for the passenger 135 to exit the vehicle 105. The vehicle seat auto-adjust system 115 detects the opening and the closing of the rear driver-side door before resuming the action of moving the driver seat 126 backwards over the remaining distance. The sum of the third distance and the remaining distance equals the second distance “d3.”

As described above, at block 665, a determination is made whether the driver 125 has exited the vehicle 105. If the driver 125 has not yet exited the vehicle 105, the action indicated in block 665 is repeated in a recursive manner until the driver 125 exits the vehicle 105. On the other hand, if the driver 125 has exited the vehicle 105, at block 670, the driver seat 126 is moved forwards over a distance that corresponds to distance over which the driver seat 126 was moved backwards as described above with reference to block 635.

Various other actions in addition to, or in lieu of, the actions described above with reference to the flowchart 600 can be executed by the vehicle seat auto-adjust system 115. Such actions can be carried out on any of the various seats in the vehicle 105. For example, in one embodiment, the vehicle seat auto-adjust system 115 may determine that the front passenger seat 131 has been pushed back by the passenger 130 to a significant extent as a result of a personal preference of the passenger 130. For example, the front passenger seat 131 may be pushed back over a distance that encompasses 50% of a first separation distance between a rear edge of the front passenger seat 131 and a front edge of the rear passenger seat 141. In this case, upon detecting an opening of the front passenger-side door, the vehicle seat auto-adjust system 115 may move the front passenger seat 131 further back (for example, 70% of the first separation distance) so as to allow the passenger 130 to exit the vehicle 105. After detecting that the passenger 130 has exited the vehicle 105, the vehicle seat auto-adjust system 115 may move the front passenger seat 131 forwards to create a second separation distance that is greater than the first separation distance (the front edge of the front passenger seat 131 close to the front console, for example) in order to allow the passenger 140 seated in the rear passenger seat 141 to comfortably exit the vehicle 105.

In another embodiment, the vehicle seat auto-adjust system 115 may assign priorities to various seats in the vehicle 105 and move a seat backwards or forwards based on the priority. Thus, for example, in one case, the rear passenger seat 141 may be assigned a higher priority than the front passenger seat 131. Consequently, the vehicle seat auto-adjust system 115 may move the front passenger seat 131 forwards to allow the passenger 140 to exit the vehicle 105 ahead of the passenger 130, upon detecting that both the passenger side doors have been opened in a concurrent manner. The front passenger seat 131 may be moved forward to create a first separation distance between the rear edge of the front passenger seat 131 and the front edge of the rear passenger seat 141.

Moving the front passenger seat 131 forwards at this time provides more room for the passenger 140 to exit the vehicle 105 in a comfortable manner. The vehicle seat auto-adjust system 115 may then move the front passenger seat 131 backwards after the passenger 140 has exited the vehicle 105. The front passenger seat 131 may, for example, be moved backwards to create a second separation distance that is greater than the first separation distance so as to allow the passenger 130 to exit the vehicle 105 comfortably.

In another embodiment, at block 610 of the flowchart 600, the vehicle seat auto-adjust system 115 may detect an object such as, for example, a large box, that is placed upon the rear passenger seat 136 (in place of the passenger 135). A front edge of the large box protrudes beyond the front edge of the rear passenger seat 136. In this case, at block 645, the vehicle seat auto-adjust system 115 may determine an available separation distance between the rear edge of the driver seat 126 and the front edge of the object. The subsequent blocks of the flowchart 600 are executed based on this available separation distance. In an example scenario, the vehicle seat auto-adjust system 115 may disable auto adjustment of the driver seat 126 upon determining that the object is too large and does not permit movement of the driver seat 126 backwards.

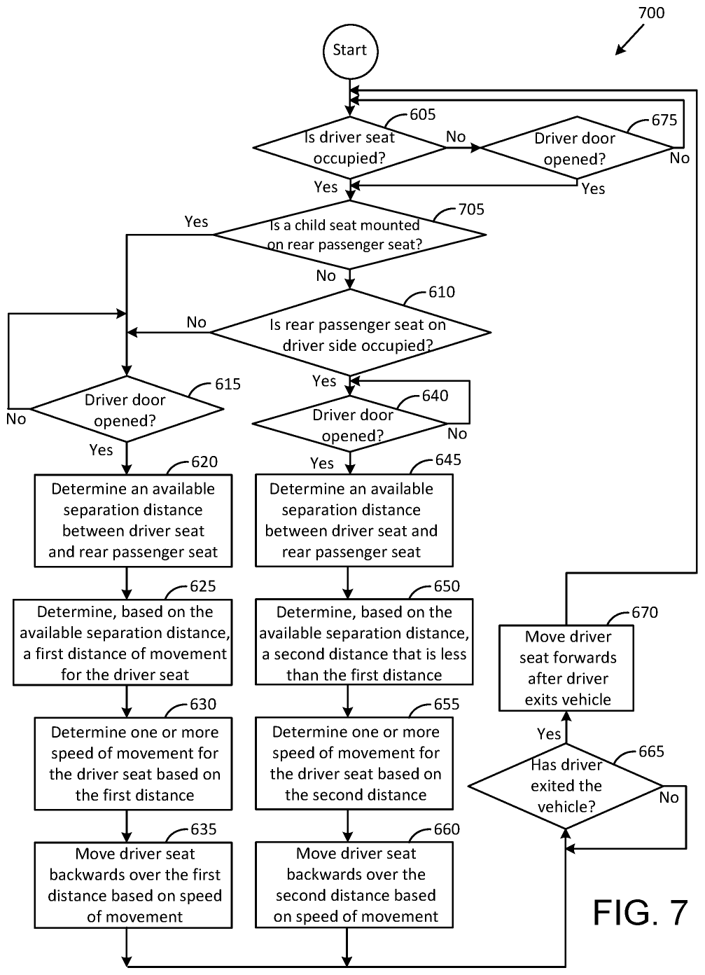

FIG. 7 shows a second example flowchart 700 of an operation executed by the vehicle seat auto-adjust system 115 in accordance with a second embodiment of the disclosure. The flowchart 700 is identical to the flowchart 600 described above except for the inclusion of a block 705. At block 705, a determination is made whether a child seat is mounted upon the rear passenger seat 136. In the example scenario illustrated in FIG. 4, a child seat 406 is mounted upon the rear passenger seat 136. The child seat 406 may or may not be occupied in this example scenario. When occupied, no body part (foot, hand, etc.) of a child 405 seated in the child seat 406 extends beyond the front edge of the rear passenger seat 136. The available separation distance corresponds to the separation distance “d1” that is illustrated in FIG. 4.

Consequently, if at block 705 it is determined that a child seat is mounted upon the rear passenger seat 136, the action indicated in block 615 and subsequent blocks are executed. In an example implementation, the vehicle seat auto-adjust system 115 may detect the presence of the child seat upon the rear passenger seat 136 by evaluating an image provided by the camera 170.

If at block 705 it is determined that no child seat is mounted upon the rear passenger seat 136, the action indicated in block 610 and subsequent blocks are executed.

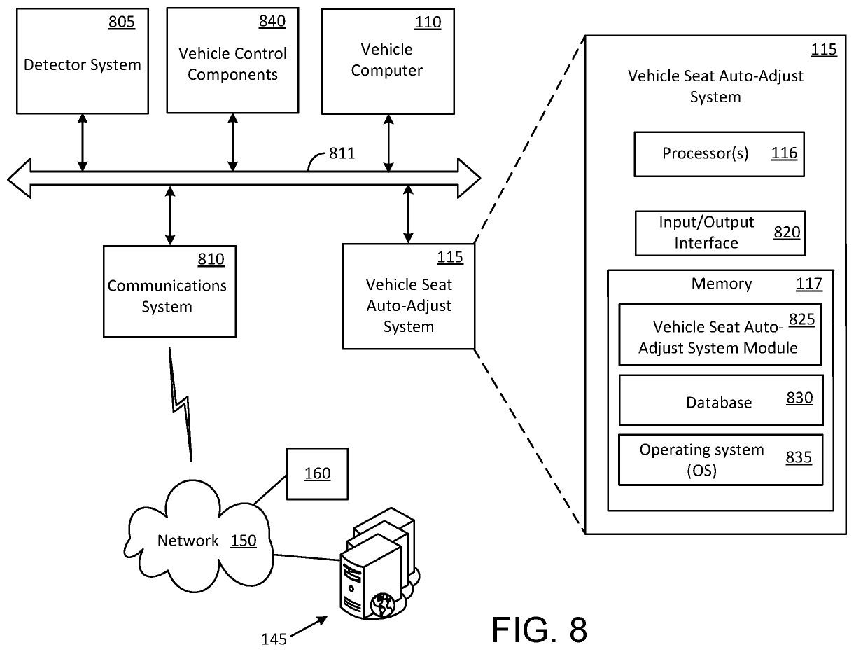

FIG. 8 shows some example components that can be included in the vehicle 105 in accordance with an embodiment of the disclosure. The example components can include a detector system 805, vehicle components 840, the vehicle computer 110, a communications system 810, and the vehicle seat auto-adjust system 115. The various components are communicatively coupled to each other via one or more buses such as an example bus 811. The bus 811 may be implemented using various wired and/or wireless technologies. For example, the bus 811 can be a vehicle bus that uses a controller area network (CAN) bus protocol, a Media Oriented Systems Transport (MOST) bus protocol, and/or a CAN flexible data (CAN-FD) bus protocol. Some or all portions of the bus 811 may also be implemented using wireless technologies such as Bluetooth®, Ultra-Wideband, Wi-Fi, Zigbee®, or near-field-communications (NFC).

The detector system 805 can include various types of detectors such as, for example, the camera 155, the camera 170, the radar detector 175, the sensor 127, the sensor 137, the sensor 132, and the sensor 142 that are shown in FIG. 1, and can also include the camera 505 shown in FIG. 5. Signals and/or images produced by the various detectors can be conveyed to the vehicle seat auto-adjust system 115 via the bus 811. The vehicle seat auto-adjust system 115 can convey commands to the various detectors via the bus 811 for executing various actions such as, for example, to a camera for capturing an image of an object or an interior cabin area of the vehicle 105.

The vehicle components 840 can include various components and systems associated with driving functions of the vehicle 105 (such as, for example, the engine, brakes, accelerator, and fuel injection) and various components that are associated with operations in accordance with the disclosure. The various components associated with operations in accordance with the disclosure can include, for example, door latches, door locks, door sensors, and door switches. The various components may be controlled, activated, and/or operated by the vehicle computer 110 and/or by the vehicle seat auto-adjust system 115.

The communications system 810 an include various components such as, for example, a wireless transmitter, a wireless receiver, and/or a wireless transceiver, that are configured to allow the vehicle seat auto-adjust system 115 to communicate via the network 150, with devices such as, for example, the computer 145 and the cloud storage device 160.

In one implementation, the vehicle seat auto-adjust system 115 can be an independent device (enclosed in an enclosure, for example). In another implementation, some or all components of the vehicle seat auto-adjust system 115 can be housed, merged, or can share functionality, with the vehicle computer 110. For example, an integrated unit that combines the functionality of the vehicle seat auto-adjust system 115 with that of the vehicle computer 110 can be operated by a single processor and a single memory device. In the illustrated example configuration, the vehicle seat auto-adjust system 115 includes the processor 116, an input/output interface 820, and a memory 117.

The input/output interface 820 is configured to provide communications between the vehicle seat auto-adjust system 115 and other components such as the detector system 805 (for receiving images from the cameras, for example).

The memory 117, which is one example of a non-transitory computer-readable medium, may be used to store an operating system (OS) 835, a database 830, and various code modules such as a vehicle seat auto-adjust system module 825. The code modules are provided in the form of computer-executable instructions that can be executed by the processor 116 for performing various operations in accordance with the disclosure.

The database 830 may be used to store information pertaining to the disclosure such as, for example, specifications pertaining to the vehicle 105 such as, for example, separation distances, seat characteristics (motorized, non-motorized etc.), and preferred seat positions.

The vehicle seat auto-adjust system module 825 may be executed by the processor 116 for performing various operations in accordance with the disclosure including, for example, the various operations disclosed in the flowchart 600 and the flowchart 700 described above.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” or “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize one or more devices that include hardware, such as, for example, one or more processors and system memory, as discussed herein. An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, such as the processor 205, cause the processor to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

A memory device such as the memory 117, can include any one memory element or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, the memory device may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Hash memory) (electronic), and a portable compact disc read-only memory (CD ROM) (optical). Note that the computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not in function.

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
detecting, by a processor, an opening of a first door of a vehicle, the first door located adjacent to a first seat in the vehicle;
determining, by the processor, an occupancy status of a second seat located behind the first seat in the vehicle; and
executing, by the processor, a seat movement operation based on the occupancy status of the second seat, the seat movement operation comprising one of moving the first seat backwards over a first distance or moving the first seat backwards over a second distance that is smaller than the first distance.

2. The method of claim 1, wherein the first seat is a driver seat of the vehicle and the second seat is a passenger seat located behind the driver seat, and wherein determining the occupancy status of the passenger seat comprises one of determining that a passenger is seated in the passenger seat or that the passenger seat is unoccupied.

3. The method of claim 2, further comprising one of moving the first seat backwards over the second distance based on determining that the passenger is seated in the passenger seat or moving the first seat backwards over the first distance based on the passenger seat being unoccupied.

4. The method of claim 3, further comprising moving the first seat backwards at one of a first speed of movement or a second speed of movement based on an available separation distance between the driver seat and the passenger seat after determining that the passenger is seated in the passenger seat.

5. The method of claim 1, wherein the first seat is a driver seat of the vehicle and the second seat is a passenger seat located behind the driver seat, and wherein determining the occupancy status of the passenger seat comprises determining that a child seat is mounted upon the passenger seat.

6. The method of claim 5, further comprising:
moving the first seat backwards over the first distance based on determining that the child seat is mounted upon the passenger seat.

7. A method comprising:
determining, by a processor, an occupancy status of a second seat that is located behind a first seat in a vehicle; and
executing, by the processor, a seat movement operation of the first seat, based on the occupancy status of the second seat.

8. The method of claim 7, wherein the occupancy status of the second seat is determined by evaluating a detector signal, and wherein the seat movement operation comprises one of moving the first seat backwards over a first distance based on the second seat being unoccupied, or moving the first seat backwards over a second distance that is smaller than the first distance based on the second seat being occupied.

9. The method of claim 8, further comprising moving the first seat backwards at one of a first speed of movement or a second speed of movement based on an available separation distance between the first seat and the second seat.

10. The method of claim 8, further comprising:
detecting, by the processor, an opening of a first door of the vehicle, the first door located adjacent to the first seat in the vehicle; and
executing, by the processor, the seat movement operation, based on detecting the opening of the first door of the vehicle.

11. The method of claim 8, wherein the first seat is a driver seat of the vehicle and the second seat is a passenger seat located behind the driver seat, and wherein determining the occupancy status of the passenger seat comprises determining that a child seat is mounted upon the passenger seat.

12. The method of claim 11, further comprising:
moving the first seat backwards over the first distance based on determining that the child seat is mounted upon the passenger seat.

13. The method of claim 8, further comprising:
detecting, by the processor, an individual approaching the vehicle; and
executing, by the processor, the seat movement operation, based on detecting the individual approaching the vehicle.

14. The method of claim 13, wherein detecting the individual approaching the vehicle is based on receiving a wireless signal from a wireless device carried by the individual and/or based on evaluating an image captured by a camera provided in the vehicle.

15. A vehicle comprising:
a detector; and
a computer, comprising:
a memory that stores computer-executable instructions; and
a processor configured to access the memory and execute the computer-executable instructions to perform operations comprising:
determining, based on evaluating information received from the detector, information about an occupancy status of a second seat that is located behind a first seat in the vehicle; and
executing, by the processor, a seat movement operation of the first seat, based on the occupancy status of the second seat.

16. The vehicle of claim 15, wherein the detector is one of a camera or a seat sensor, the camera configured to convey at least a first image that provides information about the occupancy status of the second seat, the seat sensor configured to convey a sensor signal that provides information about the occupancy status of the second seat.

17. The vehicle of claim 15, wherein the first seat is a motorized driver seat that is controlled by the processor and the second seat is a passenger seat located behind the motorized driver seat, and wherein determining the occupancy status of the passenger seat comprises one of determining that a passenger is seated in the passenger seat or that the passenger seat is unoccupied.

18. The vehicle of claim 17, wherein the processor is further configured to access the memory and execute the computer-executable instructions to perform additional operations comprising:
one of moving the motorized driver seat backwards over a first distance based on the passenger seat being unoccupied, or moving the motorized driver seat backwards over a second distance that is smaller than the first distance based on the passenger seat being occupied.

19. The vehicle of claim 18, wherein the processor is further configured to access the memory and execute the computer-executable instructions to perform additional operations comprising:
determining, based on evaluating information received from the detector, that a child seat is mounted upon the passenger seat; and
moving the first seat backwards over the first distance based on determining that the child seat is mounted upon the passenger seat.

20. The vehicle of claim 17, wherein the processor is further configured to access the memory and execute the computer-executable instructions to perform additional operations comprising:
moving the motorized driver seat backwards at one of a first speed of movement or a second speed of movement based on an available separation distance between the motorized driver seat and the passenger seat.
